(19) United States
(12) Patent Application Publication
(10) Pub. No.: US 2015/0086686 A1
(43) Pub. Date: Mar. 26, 2015

(54) INSOLUBLE FIBER COMPOSITION AND METHOD FOR MAKING SAME

(71) Applicant: Access Business Group International LLC, Ada, MI (US)

(72) Inventors: Troy P. Nietling, Lowell, MI (US); Eugene R. Maly, Kentwood, MI (US); Kerry Grann, Lansing, MI (US); Jesse Huss, Jenison, MI (US)

(73) Assignee: Access Business Group International LLC, Ada, MI (US)

(21) Appl. No.: 14/475,080

(22) Filed: Sep. 2, 2014

Related U.S. Application Data
(60) Provisional application No. 61/881,225, filed on Sep. 23, 2013.

(51) Int. Cl. A23L 1/308

(52) U.S. Cl. CPC A23L 1/308; A23V 2002/00
USPC 426/250; 426/658

(57) ABSTRACT

A composition is described that includes at least about 10% of a dietary fiber component such that at least about 50% of the dietary fiber component is provided by insoluble fiber. A method for making such a composition is also described.

### RELATED APPLICATIONS

The present patent document claims the benefit of the filing date under 35 U.S.C. §119(e) of Provisional U.S. Patent Application Ser. No. 61/881,225, filed Sep. 23, 2013, which is hereby incorporated by reference.

### BACKGROUND

The present disclosure relates generally to an insoluble fiber composition. In one embodiment the composition is a soft and chewy confectionary with a high dietary fiber content that includes a greater amount of insoluble fiber than soluble fiber.

It is well-known that fiber is an important part of the diet of mammals, particularly humans. Medical and nutrition professionals generally agree that dietary fiber is essential for good human health. Too little fiber in the diet is associated with diseases such as heart disease, diabetes, obesity, and colon cancer. In addition, too little fiber often results in intestinal irregularity. Proper amounts of fiber in the diet stimulate bowel movement, slow down the gastrointestinal transition and digestion processes, modify fat absorption, and increase excretion of bile acids. In addition, some dietary fibers are known to lower blood cholesterol and benefit the postprandial (after eating) glycemic response. In addition, various types of fiber and/or fiber components, for example, moderately fermentable fiber that is fermented by the intestinal flora of a user, has been shown to promote the growth and/or development of lactic acid bacteria in the gastrointestinal tract of a user, at the expense of pathogenic bacteria, thus providing benefit to the user's gastrointestinal tract.

Fiber is commonly classified as soluble (it dissolves in water) or insoluble (it doesn't dissolve). Soluble fiber dissolves in water to form a gel-like material. It can help lower blood cholesterol and glucose levels. Soluble fiber is found in oats, peas, beans, apples, citrus fruits, carrots, barley and psyllium. Insoluble fiber does not dissolve in water and it promotes the movement of material through your digestive system and increases stool bulk, so it can be of benefit to those who struggle with constipation or irregular stools. Whole-wheat flour, wheat bran, nuts, beans and vegetables, such as cauliflower, green beans, peas, and potatoes, are good sources of insoluble fiber. Most plant-based foods, such as oatmeal, peas, beans, and the like contain both soluble and insoluble fiber.

It has been documented that the average person in the United States does not eat enough dietary fiber, and often eats only about half of the recommended amount of fiber daily. Fiber intake can be increased by eating greater amounts of foods high in fiber such as grains, fruits, and vegetables. However, most consumers would have to almost double their intake of such foods to attain the recommended daily amount of fiber. Many consumers are unwilling or unable to eat large amounts of high fiber foods, and thus often look for supplements to provide the additional needed fiber.

To date there are several types and brands of fiber supplements available including powders, tablets, capsules, biscuits, breakfast cereals, laxative beverages, and the like. However, many of these compositions have certain drawbacks and are not easily accepted by consumers due to various factors such as the lack of portability, for example of powders or beverages; the unpleasant taste, and texture and/or mouthfeel of many fiber containing materials; high calories of the supplement resulting from materials used to mask the taste and/or texture of the fiber; and excess gas produced in the user by many of the fiber containing materials. In addition, flavoring, taste masking, and texture enhancing materials added to the fiber supplement products result in a lessened amount of fiber that can be included in each unit of product. Therefore, consumers must ingest increased amounts of product to obtain the desired amounts of fiber. Such unpleasant and/or inconvenient properties often result in the user discontinuing use of the product.

Recently there have been attempts to formulate fiber into a palatable, easily ingestible confectionary-type article, such as a soft chew. However, such chews are generally difficult to manufacture due to the propensity of the presence of too much fiber to result in a confection that is too hard and/or brittle for general consumer acceptance. Thus, many of the currently available confection-type products suffer from many of the noted drawbacks such as unpleasant taste and mouthfeel, high calories, and many also contain relatively small amounts of fiber, therefore requiring that the user ingest several units of product per day in order to obtain the desired amount of fiber.

Moreover, the available fiber articles contain either all soluble fiber or contain a significant amount of soluble fiber, i.e., a greater amount of soluble fiber than insoluble fiber. Thus, there is a need for an edible product that provides a significant amount of insoluble fiber and particularly an edible product that contains an amount of insoluble fiber that is greater than the amount of soluble fiber.

### SUMMARY

According to the present invention a dietary fiber composition includes from about 10% to about 40% dietary fiber such that at least about 50% of the dietary fiber is an insoluble fiber, from about 25% to about 75% sweetener, and from about 1% to about 10% blending agent. In some embodiments, the dietary fiber includes substantially all insoluble fiber. In some embodiments, the composition is formulated as a soft chewy confectionary product.

The product according to the present invention can be made in the following manner. Combine and mix the sweetener(s) with a portion, e.g., 50% of the dietary fiber at a temperature sufficient to dissolve the dietary fiber, e.g., 250° F. to form a first mixture. If the dietary fiber contains soluble fiber, it is desirable if a portion of the soluble fiber was combined with the sweetener. Remove a portion of the first mixture, e.g., about 50% and combine the first mixture with the blending agent until the blending agent is melted or fully incorporated to form a second mixture.

Combine and mix the flavors and colors and then add them to the second mixture. Combine and mix the insoluble fibers and the remaining soluble fiber and then add them to the second mixture. Thereafter, combine the remaining portion of the first mixture with the second mixture and blend until uniform.

The uniform mixture can then be cooled, extruded, and cut into the desired portion size.

All percentages and ratios are calculated by weight unless otherwise indicated. All percentages and ratios are calculated based on the total final composition unless otherwise indicated.

The term “soluble fiber” refers to the edible parts of plants or similar carbohydrates resistant to digestion and absorption in the human small intestine with complete or partial fermentation in the large intestine. The terms “total dietary fiber” or “dietary fiber” are understood to be the sum of the soluble and insoluble dietary fiber determined by AACC Method 32-07 and wherein by weight at least 70% of the fiber source comprises dietary fiber. A soluble dietary fiber source is one in which at least 60% of the dietary fiber is soluble dietary fiber as determined by AACC Method 32-07, and an insoluble dietary fiber source is a fiber source in which at least 60% of the total dietary fiber is insoluble dietary fiber as determined by AACC Method 32-07.

The term “DE” means “dextrose equivalent”, which refers to the percent of reducing sugars on a dry basis calculated as dextrose. One of skill in the art would be familiar with the measure and terminology “DE” and “dextrose equivalent”. Glucose (or corn) syrups are formed by reacting a starch with an acid and/or an enzyme. DE is a measurement of the degree of hydrolysis that starches undergo. Standard corn syrups generally have a DE of about 42. The higher the DE, the sweeter the component. However, higher DE also can contribute to a composition's greater tendency to crystallize, tendency to discolor, and tendency to be more hygroscopic, and can result in lower viscosity.

These and other features and advantages of the invention will become apparent upon consideration of the following detailed description of the presently preferred embodiments, viewed in conjunction with the appended drawings.

### DETAILED DESCRIPTION

According to the present invention a dietary fiber composition includes from about 10% to about 40% dietary fiber such that at least about 50% of the dietary fiber is an insoluble fiber, from about 25% to about 75% sweetener, and from about 1% to about 10% blending agent.

### Dietary Fiber

Food sources of dietary fiber are often divided according to whether they provide (predominantly) soluble or insoluble fiber. Plant foods contain both types of fiber in varying degrees, according to the plant's characteristics. Fiber or dietary fiber generally refers to the indigestible portion of food derived from plants. There are two main components of fiber: soluble fiber and insoluble fiber. Soluble fiber dissolves in water and is readily fermented in the colon into gases and physiologically active byproducts, and can be prebiotic and/or viscous. Insoluble fiber does not dissolve in water. It can be metabolically inert and provide bulking. Bulking fibers absorb water as they move through the digestive system, easing defecation. Insoluble fibers tend to accelerate the movement of food through the system.

Chemically, dietary fiber consists of non-starch polysaccharides such as arabinoxylans, cellulose, and many other plant components such as resistant starch, resistant dextrins, inulin, lignin, waxes, chitins, pectins, beta-glucans, and oligosaccharides.

### Soluble Fiber

Non-limiting examples of soluble fiber components useful in the present invention can include complex carbohydrates, such as long-chained sugars also called starch, oligosaccharides, polysaccharides, beta-glucans, pectins, natural gums, inulins, and resistant dextrins. For example, the soluble fiber component may include naturally derived inulin; inulin extract; synthetic inulin; hydrolysis products of inulin commonly known as fructooligosaccharides, galacto-oligosaccharides, and xylooligosaccharides. Other examples include carrageenan, alginate, tara gum, tamarind gum, gum arabic, gaur gum, locust bean gum, karaya gum, gellan gum, rhamsan, gum, welan gum, diutan gum, xanthan gum, agar, citrus pectin, carboxymethylcellulose, hydroxypropyl cellulose, hydroxypropyl methyl cellulose, hydroxyethyl cellulose, sodium carboxymethylcellulose, low and high methoxy pectin, barley glucans, konjac mannan, arabinoxylans, β-glucans, xyloglucans, curdlan, dextran, and psyllium.

The inulin may be a de-sugared inulin. Inulin is a linear oligomer that includes β-D-fructose linked to a terminal α-D-glucose. Inulin has the structural formula GFrₙ, wherein G is α-D-glucose, Fr is β-D-fructose; and n is an integer of between 2 to 60. Inulin is often referred to as a “fructan”, an “oligofructan”, and an “oligofructose”.

The term “naturally derived” means not chemically processed from its natural source. For example, inulin can be naturally derived by boiling chicory root in water then drying the resulting water portion to yield inulin.

The term “de-sugared inulin” means a non-gelling form of inulin having a total of about 2% (by weight) maximum mono and disaccharides, and having about 95% (by weight) minimum soluble fiber. De-sugared inulin can be prepared by passing the water component, after boiling of chicory root in water, through a filter before drying. The filter removes mono and disaccharides.

### Insoluble Fiber

Non-limiting examples of insoluble fiber components useful in the present invention include those fiber compounds with partial or low fermentability and include cellulose, hemicellulose, lignans, plant waxes, and resistant starches. For example, oat fiber, pea fiber, soy fiber, beet fiber, cellulose, corn bran, acerola fiber, sugar cane fiber.

The compositions of the present invention include at least about 10%, alternatively at least about 15%, alternatively at least about 20% of dietary fiber. In some embodiments, the dietary fiber is present in an amount up to about 40%, alternatively, up to about 30%, alternatively up to about 25%. Moreover and advantageously, insoluble fiber comprises at least about 50% of the dietary fiber present in the present composition, alternatively at least about 55%, alternatively at least about 60%, alternatively at least about 65%, alternatively at least about 70%, alternatively at least about 75%, alternatively at least about 80%, alternatively at least about 90%, and alternatively about 100%. In some cases the insoluble fiber constitutes substantially all of the dietary fiber.

### Sweetener

The present composition includes sweeteners to offset or mask poor tasting ingredients. Suitable sweeteners include syrups such as corn syrup, brown rice syrup, juice concentrates such as apple juice concentrate, grape juice concentrate, maple sugar, molasses, honey non-invert sugar such as sucrose, glucose, mannose, galactose, ribose, lactose, and maltose among others. In some instances, sugar alcohols may replace a portion of the sugars/carbohydrates.

The sweetener can be present in the composition in amounts from about 25% to about 75%, alternatively from about 30% to about 70%, alternatively from about 35% to about 65% of the present composition.

### Blending Agent

Embodiments of the compositions of the present invention can include at least about 0.01%, by weight of the composition, of one or more blending agents. Alternatively the blending agent, individually or as a mixture, can comprise from about 0.01% to about 20%, alternatively from about 0.01% to about 10%, alternatively from about 0.01% to about 5%, and alternatively from about 0.01% to about 4%, by weight of the composition.

Non-limiting examples of suitable blending agent components include polyglycerol esters, glycerophospholipids, mono- and di-glycerides, sucrose monoesters, sorbitan esters, polyethoxylated glycols, agar, albumin, casein, glyceryl monostearate, gums, soaps, irish moss, egg yolk, lecithin, and mixtures thereof.

### Flavor, Colorant, and Preservative Components

Various additional components including natural and artificial flavors, natural and artificial colorants and/or food grade dyes can be included in the compositions of the present invention. In addition, various preservatives, as would be understood by those of ordinary skill in the art can also be added.

Non-limiting examples of flavors include natural or artificial flavors and include chocolate; vanilla; caramel; coffee; fruit flavors including lemon, lime, orange, blackberry, raspberry, blueberry, peach, apricot, cherry, grape; creme, and mixtures thereof. Such flavors can be purchased, and/or prepared and added using known flavor technologies.

Non-limiting examples of suitable colorants include elderberry, caramel coloring made from caramelized sugar, Annatto, Chlorophyllin, Cochineal, Betanin, Turmeric, Saffron, Paprika, Lycopene, Pandan, and Butterfly pea.

Non-limiting examples of suitable preservatives include: sodium benzoate, sodium citrate, sodium phosphate, potassium metabisulfite, sodium metabisulfite, sodium lactate, sodium sulfite, EDTA (ethylenediaminetetraacetic acid), methylparaben, citric acid, ascorbic acid, malic acid, and mixtures thereof.

The compositions of the present invention can include, individually or totally, at least about 0.001%, by weight of the composition, of flavor, colorant, and/or preservative components, and mixtures thereof. Alternatively, the compositions of the present invention can include, individually or totally, from about 0.001% to about 10%, alternatively from about 0.001% to about 5%, alternatively from about 0.01% to about 4%, alternatively from about 0.1% to about 3% by weight of the composition, of each or the flavor, colorant components, and/or preservative components and mixtures thereof.

### Supplement Components

While the present composition is primarily intended to be a fiber composition, it is contemplated that embodiments of the invention can include supplements such as, but not limited to, vitamins, minerals, herbs, botanicals, plant derived supplements, animal derived supplements, therapeutic compounds, and mixtures thereof.

Non-limiting examples of such other components include: calcium, potassium, B vitamins, vitamins A, C, D, E, and K, folic acid, other vitamins and minerals commonly known in the art and used for supplementing the diet; extracts and active phytochemicals including ferulic acid (from apples), ginseng, ginko biloba, beta carotene, capsicanoids, anthocyanidins, bioflavinoids, d-limonene, isothiocyanates, cysteines from garlic, ginger, grapes, catechins and polyphenols from teas, onions, phytosterols, isoflavones, lycopene, curcumin, caffeine; glucosamine, chondroitin,; melatonin, seratonin; and mixtures thereof.

The compositions of the present invention can include at least about 0.001%, by weight of the composition, of a supplement component. Alternatively, the composition of the present invention can include from about 0.001% to about 25%, alternatively from about 0.01% to about 10%, and alternatively from about 0.1% to about 5%, by weight of the composition, of a supplement component.

### Form of the Composition

The compositions of the present invention can be formed into any suitable, ingestible form. Non-limiting examples of the form of the compositions include: soft chew, hard chew, chewable tablet, nutritional bar, lozenge, powder, granules, clusters, soft gel, semi-solid taffy-like chew, chewing gum, swallowable tablet, swallowable capsule, swallowable caplet, individual unit doses, user-dosable forms, and mixtures thereof. For example, a unit dose can be a single soft chew, or a partitionable form such as a bar which the user cuts or breaks to provide unit dosages.

Soft chew is intended to mean a product which is solid at room temperature and which are soft to chew and which is functionally chewy because the product has some plastic texture during the process of mastication in the mouth.

In certain embodiments of the present invention, the composition is free of unbound or added water. The term “unbound water” refers to water that is not present as part of an ingredient used in the composition of the present invention. In contrast, “bound water” refers to that water that is present as part of the ingredient, e.g., water that might be present as part of a fruit juice concentrate.

### Methods of Making

Exemplary methods of making compositions of the present invention can include one or more of the following steps.

Combine and mix the sweetener(s) with a portion, e.g., 50% of the dietary fiber at a temperature sufficient to dissolve the dietary fiber, e.g., 250° F. to form a first mixture. If the dietary fiber contains soluble fiber, it is desirable if a portion of the soluble fiber was combined with the sweetener. Remove a portion of the first mixture, e.g., about 50% and combine the first mixture with the blending agent until the blending agent until the blending agent is melted or fully incorporated to form a second mixture.

In certain embodiments, a colorant may be blended with the first mixture.

Combine and mix the flavors and colors (if they were not previously blended) and then add them to the second mixture. Combine and mix the insoluble fibers and the remaining soluble fiber and then add them to the second mixture. Thereafter, combine the remaining portion of the first mixture with the second mixture and blend until uniform.

The uniform mixture can then be cooled, extruded, and cut into the desired portion size.

Extrusion can be done, for example by adding the final mixture, adjusted to a temperature of from about 100° F. (about 38° C.) to about 120° F. (about 49° C.), to a pre-kneader, then into a final rope extruder; cooling via a cooling tunnel (cooled to from about 40° F. (about 5° C.) to about 80 F. (about 27° C.), and knife cutting into individual pieces to form soft chews having an individual weight from about 3 to about 8 grams, or from about 4 to about 7 grams, or from about 5 to about 6 grams.

The temperature of the final mixture, before delivery into the pre-kneader can be adjusted in various ways, non-limiting examples of which include: making the final mixture in a jacketed vessel, adjusting the temperature of any of the pre-mixes, and combinations thereof.

The soft chews can be wrapped in poly-lined foil wrappers or other protective barriers. The wrapped chews can then be placed in secondary packaging, non-limiting examples of which include glass bottles; plastic bottles; plastic bags, foil lined bags, cartons, or sleeves; and combinations thereof.

### Methods of Using

Embodiments of the present invention include methods of delivering a safe and effective amount of a fiber component to a user. As used herein, a “safe and effective amount” means an amount of fiber component that contributes to one or more of the following benefits: increased stool volume and moisture content; intestinal regularity; slowed gastrointestinal transition and digestion processes; modified fat absorption; aiding in weight management; increasing excretion of bile acids; aiding in lowering blood cholesterol; benefiting the postprandial glycemic response; aiding growth and/or development of beneficial gastrointestinal microorganisms; as well as helping to reduce the risk of heart disease, diabetes, obesity, and colon cancer.

A method of delivering a safe and effective amount of fiber component to a user comprises the user ingesting from about 1 to about 20 unit doses per day of a composition according to the present invention.

To deliver a desired amount of fiber component per day, a user can ingest from about 1 to about 20, alternatively from about 1 to about 10, and alternatively from about 1 to about 5 unit doses of the composition per day. For example, when the composition is formulated as a soft chew as described in this specification, each chew will be about 3 grams to 7 grams, or from about 4 grams to 6 grams.

Each unit dose can include from about 0.5 grams to about 6 grams of dietary fiber component, alternatively from about 1 gram to about 4 grams, alternatively from about 1.5 to about 2.5 grams of dietary fiber. Each unit dose can include from about 0.2 grams to about 3 grams of insoluble fiber, or from about 0.3 grams to about 2 grams, or about 0.5 grams to about 1.7 grams of insoluble fiber.

### EXAMPLES

The following examples are included for illustrative purposes only and are not intended to in any way limit the scope of the present invention.

Table I shows an example composition of the present invention.

TABLE I

| | |
|---|---|
| | % by wt. of |
| Ingredient | composition |

Sweetener

| | |
|---|---|
| Brown Rice Syrup-42 DE | 30.60 |
| Fructose | 26.94 |
| Sucrose | 5.63 |
| Grape Juice Concentrate | 2.50 |

Fiber Blend

| | |
|---|---|
| Pea Fiber (Insoluble) | 15.45 |
| Acerola Fiber (Insoluble) | 0.05 |
| Sugar Cane Fiber | 2.00 |
| (Insoluble | |
| Inulin (Soluble) | 9.66 |

Blending Agent

| | |
|---|---|
| Mono & Diglycerides | 3.70 |

Flavor, Colorant, and Preservative

| | |
|---|---|
| Elderberry Colorant | 1.00 |
| Natural Grape Flavor | 1.00 |
| Crème Extract | 0.320 |
| Citric Acid | 0.600 |
| Ascorbic Acid | 0.169 |
| Malic Acid | 0.385 |

Table II shows another example composition of the present invention.

TABLE II

| | |
|---|---|
| | % by wt. of |
| Ingredient | composition |

Sweetener

| | |
|---|---|
| Tapioca Syrup-42DE | 31.04 |
| Fructose | 25.56 |
| Inulin | 4.830 |
| Sucrose | 0.630 |
| Dark Sweet Cherry Juice | 3.300 |
| Concentrate 65% | |

Fiber Blend

| | |
|---|---|
| Acerola Fiber (Insoluble) | 9.200 |
| Sugar Cane Fiber | 9.100 |
| (Insoluble | |
| Inulin (Soluble) | 4.240 |

Blending Agent

| | |
|---|---|
| Mono & Diglycerides | 2.700 |
| Palm Oil | 3.000 |

Flavor, Colorant, and Preservative

| | |
|---|---|
| Stabilized Purple Sweet | 0.500 |
| Potato Colorant | |
| Cherry Flavor | 0.550 |
| Citric Acid | 0.600 |
| Ascorbic Acid | 0.169 |
| Malic Acid | 0.385 |
| Gum Arabic | 2.200 |
| Sunflower Lecithin | 2.000 |

While the present invention has been described with reference to specific exemplary embodiments, it will be evident that various modifications and changes may be made to these embodiments without departing from the spirit and scope of the invention. It is the following claims, including all equivalents, which are intended to define the spirit and scope of the invention.

1. A composition comprising:
a. at least about 10% of a dietary fiber component;
b. at least about 25% sweetener; and
c. at least about 1% blending agent, wherein the dietary fiber component includes at least about 50% insoluble fiber.

2. The composition of claim 1 wherein the dietary fiber component includes at least about 75% insoluble fiber.

3. The composition of claim 1 wherein the dietary fiber component includes at least about 90% insoluble fiber.

4. The composition of claim 1 wherein the dietary fiber component is substantially all insoluble fiber.

5. The composition of claim 1 wherein the sweetener is selected from the group consisting of syrups, monosaccharides, disaccharides, invert sugar, juice concentrates, and mixtures thereof.

6. The composition of claim 1 wherein the blending agent is selected from the group of monoglycerides and diglycerides.

7. A method of preparing a fiber composition comprising:
a. mixing a sweetener with a first portion of a dietary fiber at a temperature sufficient to dissolve the dietary fiber to form a first mixture;
b. combining a portion of the first mixture with a blending agent to form a second mixture;
c. combining a remaining portion of the dietary fiber and mix the combined remaining portion of the dietary fiber with the second mixture; and, d. adding a remaining portion of the first mixture to the mixture formed in step (c), and blend to form a uniform mixture.

8. The method of claim 7 further comprising extruding the uniform mixture to form an extrudate and cutting the extrudate into unit forms.

9. A method of preparing a fiber composition comprising:
e. mixing a sweetener with a first portion of a dietary fiber and a colorant at a temperature sufficient to dissolve the dietary fiber to form a first mixture;
f. combining a portion of the first mixture with a blending agent to form a second mixture;
g. combining a remaining portion of the dietary fiber and mix the combined remaining portion of the dietary fiber with the second mixture; and,
h. adding a remaining portion of the first mixture to the mixture formed in step (c), and blend to form a uniform mixture.

10. The method of claim 9 further comprising extruding the uniform mixture to form an extrudate and cutting the extrudate into unit forms.
